(19) United States
(12) Patent Application Publication
(10) Pub. No.: US 2002/0198793 A1
(43) Pub. Date: Dec. 26, 2002

(54) Method, system and apparatus for tracking an object capable of being consumed and replenished

(75) Inventors: Mahdad Majd, Rochester, MN (US); Shannon Everett Wenzel, Colby, WI (US); Ronald Dean Young, Zumbrota, MN (US)

Correspondence Address: Gero G. McClellan, Thomason, Moser & Patterson, L.L.P., Suite 1500, 3040 Post Oak Boulevard, Houston, TX, 77056-6582, US

(73) Assignee: International Business Machines Corporation, Armonk, NY (US)

(21) Appl. No.: 09/885,141

(22) Filed: Jun. 20, 2001

(51) Int. Cl. G06F 17/60

(52) U.S. Cl. 705/28

(57) ABSTRACT

A method and system for tracking an inventory of a plurality of objects capable of being consumed and replenished. In one embodiment, an object tracking device is used for each of the plurality of objects. The object tracking devices determine an amount of each of the plurality of objects that is available for consumption. The determined amount is then transmitted from the object tracking devices and received at an inventory tracking center. A supplier of at least one of the plurality of objects is notified of the determined amount when the determined amount is less than a threshold amount.

### BACKGROUND OF THE INVENTION

1. Field of the Invention

The invention relates to computer systems and devices. More particularly, the invention relates to a method and system for tracking an object capable of being consumed and replenished.

2. Background of the Related Art

Manufacturers maintain an inventory of components needed to create a product. Similarly, store owners maintain an inventory of products available to sell to consumers. When the inventory of a component or product becomes sufficiently low, e.g., drops below a predefined threshold or level, the manufacturer or store owner will need to replace or replenish the respective used component or sold product.

To prevent shortages in inventory, the manufacturer or store owner may use an automated inventory tracking system to track the inventory of different components or products. For example, the automated inventory tracking system may provide a count of each type of component in a manufacturing facility or a store. Similarly, the automated inventory tracking system may scan the bar code provided for each product available for sale in a store.

However, such automated inventory tracking systems are generally limited to fungible items. Namely, the current automated inventory tracking systems cannot count or bar-code scan an object, e.g., a component or product, that is capable of being consumed and replenished, e.g., a liquid in a container. Thus, a need exists to provide an automated inventory tracking system capable of tracking objects capable of being consumed and replenished.

### SUMMARY OF THE INVENTION

The invention provides a method, system and apparatus for tracking an inventory of a plurality of objects capable of being consumed and replenished. In one embodiment, an object tracking device is used for each of the plurality of objects. The object tracking devices determine an amount of each of the plurality of objects that is available for consumption. The determined amount is then transmitted from the object tracking devices and received at an inventory tracking center. A supplier of at least one of the plurality of objects is notified of at least one of the determined amount and a refill amount.

A system is also provided for tracking an inventory of a plurality of objects capable of being consumed and replenished. In one embodiment, the system comprises a plurality of object tracking devices for the plurality of objects, an inventory tracking center and a display device. The object tracking devices determine an amount of the respective objects available for consumption and transmit the determined amount to the inventory tracking center. The determined amount received at the inventory tracking center is displayed on a display device.

An apparatus for tracking an inventory of a plurality of objects capable of being consumed and replenished is also provided. The apparatus comprises a memory, a network interface and a processor. The memory stores an inventory tracking program. The network interface communicates with a supplier capable of replenishing at least one of the plurality of objects, and communicates with a plurality of object tracking devices for the plurality of objects. Each of the object tracking device determines an amount of each object that is available for consumption and transmits the determined amount for each object. The processor, upon executing the inventory tracking program, is configured to receive a signal from the plurality of object tracking devices and notify the supplier of at least one of the determined amount and a refill amount for at least one of the plurality of objects.

### BRIEF DESCRIPTION OF THE DRAWINGS

The teachings of the present invention can be readily understood by considering the following detailed description in conjunction with the accompanying drawings, in which:

FIG. 1 depicts a system for tracking a plurality of objects capable of being consumed and replenished;

FIG. 2 depicts a block diagram of an inventory tracking center in the system of FIG. 1;

FIG. 3 depicts a data structure of a signal transmitted from a remote computer terminal to the inventory tracking center;

FIG. 4 depicts a data structure of a signal stored in a memory of the inventory tracking center;

FIG. 5 depicts a data structure of a signal transmitted from an object tracking device to the inventory tracking center;

FIG. 6 depicts a flow diagram of a method for processing input data received at the inventory tracking center;

FIG. 7 depicts a flow diagram of one embodiment of a method for collecting data from objects; and

FIG. 8 depicts a flow diagram of another embodiment of a method for collecting data from objects.

To facilitate understanding, identical reference numerals have been used, where possible, to designate identical elements that are common to the figures.

### DETAILED DESCRIPTION OF THE PREFERRED EMBODIMENTS

A method, system and apparatus for tracking an inventory of a plurality of objects capable of being consumed and replenished. In one embodiment, an object tracking device is used for each of the plurality of objects. The object tracking devices determine an amount of each of the plurality of objects that is available for consumption. The determined amount is then transmitted from the object tracking devices and received at an inventory tracking center. A supplier of at least one of the plurality of objects is notified of the determined amount.

Various programs and devices described hereinafter may be identified based upon the application for which they are implemented in a specific embodiment of the invention. However, it should be appreciated that any particular program or device nomenclature that follows is used merely for convenience, and the invention is not limited to use solely in any specific application identified and/or implied by such nomenclature.

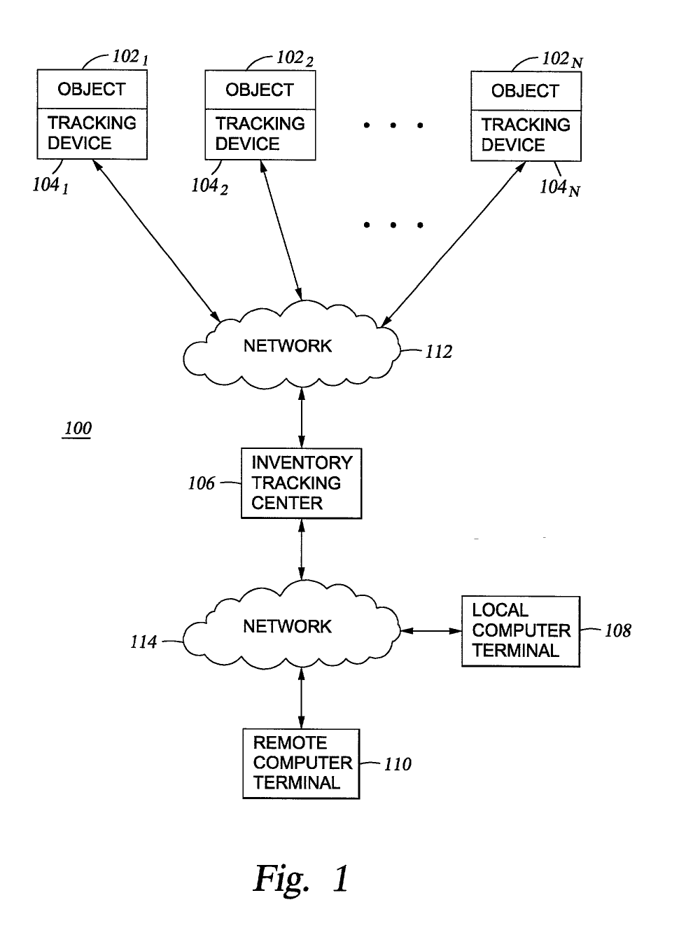

FIG. 1 depicts a system 100 for tracking a plurality of objects 102₁, 102₂, . . . , 102_{N} (generally referred to hereinafter as 102) capable of being consumed and/or replenished. Specifically, the system 100 provides automated tracking of these objects 102 and provides the results of the tracking to a computer terminal 108 or 110. A supplier may then view the results and replenish one or more of the objects 102.

In one embodiment, the system 100 comprises a plurality of object tracking devices 104₁, 104₂, . . . , 104_{N} (generally referred to hereinafter as 104), an inventory tracking center 106, a local computer terminal 108 and a remote computer terminal 110. The object tracking devices 104 and the inventory tracking center 106 may communicate via a network 112. The local computer terminal 108 and the remote computer terminal 110 communicate with the inventory tracking center 106 via a network 114. In one embodiment, the networks 112 and 114 are the same.

The objects 102 represent any item that is capable of being consumed and/or replenished. The different objects 102 in the system 100 may be the same type of object or different types of objects. In one embodiment, each of the objects 102 is stored in either an open or closed container (not shown). General examples of objects 102 may include a liquid or multiple solids in either an open or closed container or a gas in a closed container. The objects 102 may in a household setting or a manufacturing setting. For example, the object 102 may comprise a household item, e.g., liquid in a closed container. The object 102 may comprise liquid or fluid stored in a tank.

In one embodiment, the system 100 has one object tracking device 104 for each object 102. The object tracking device 104 may be coupled to a container containing the object 102. Initially, the object tracking device 104 determines, e.g., measures, an amount of the object 102 that is still available for consumption. Once the amount of object 102 available has been determined, the object tracking device 104 transmits the determined (remaining) amount of the object 102 to the network 112.

The object tracking device 104 may determine and transmit the available amount of the object 102 in response to a request signal from the inventory tracking center 106 via the network 112. The object tracking device 104 may also be configured to perform this determination and transmission in a repeated manner. For example, the object tracking device 104 may determine the amount of available object 102 on a daily basis and transmit the determined amount to the inventory tracking center 106.

The object tracking devices 104 may have varying levels of complexity within the system 100. For example, a relatively simple form the object tracking device 104 may include level sensors, pressure sensors, and the like. More complex forms of the object tracking device 104 may include a computer controlled units, e.g., a personal computer, having a processor running an operating system.

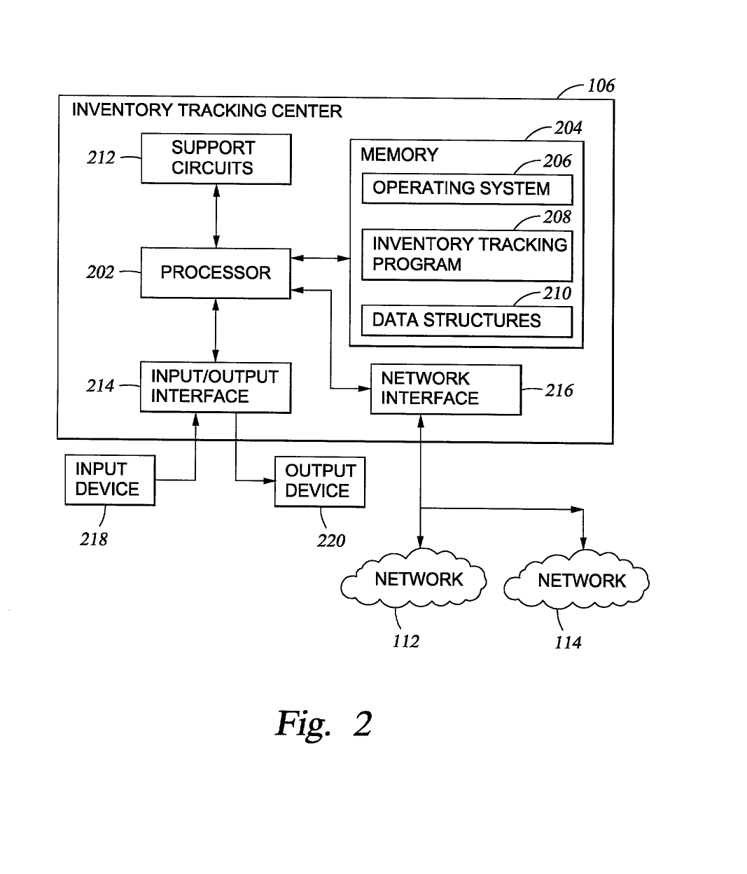

The inventory tracking center 106 tracks the inventory of the plurality of objects 102 in the system 100. The inventory tracking center 106 may be operated by a suppler of one or more of the objects 102. Additionally, the inventory tracking center 106 may be operated by different users or suppliers at different locations, e.g., different remote computer terminals 110. One embodiment of the inventory tracking center 106 is further described with respect to FIG. 2.

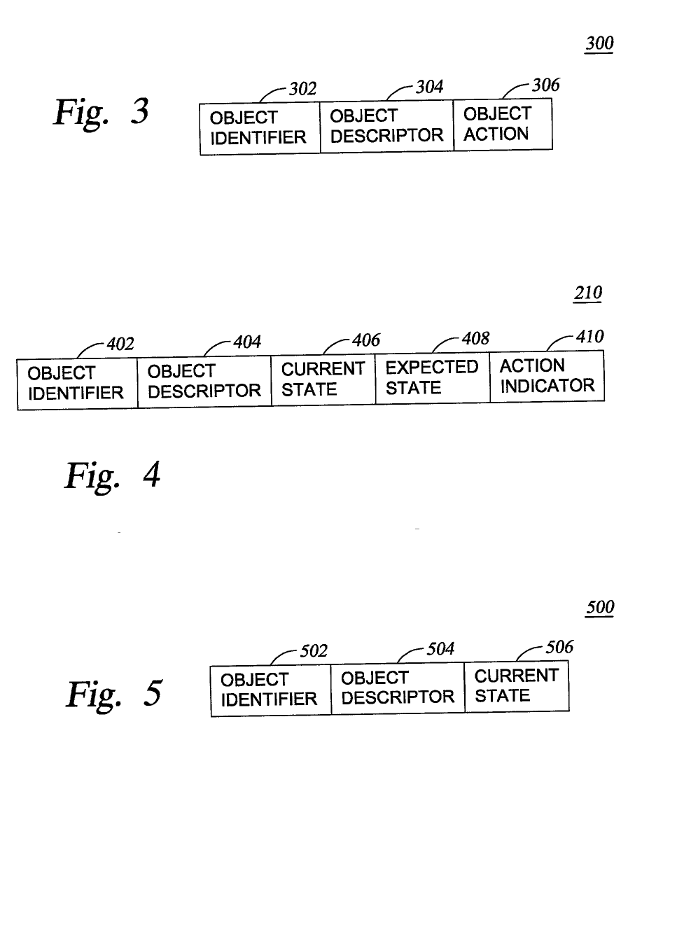

The inventory tracking center 106 receives signals from the network 112 or 114. An exemplary data structure of a signal received via the network 112 from the object tracking device 104 is further described with respect to FIG. 5. An exemplary data structure of a signal received via the network 114 from the remote computer terminal 110 is further described with respect to FIG. 3.

To determine whether the received signal is from the object tracking device 104, the inventory tracking center 106 determines whether the received signal contains an object identifier for the object 102. If the object identifier is for one the objects 102 in the system 100, the determined amount of the object is stored in the inventory tracking center 106 for further processing. For example, the inventory tracking center 106 may determine whether the amount of any of the objects 102 has dropped below a certain level and/or notify a supplier of the object 102 at a local computer terminal 108 or a remote computer terminal 110.

The inventory tracking center 106 may also receive a command to obtain the status or amount available of the objects 102 in the system 100. Illustratively, the command is received from either the local computer terminal 108 or the remote computer terminal 110 via the network 114. In response to the command, the inventory tracking center 106 may obtain the available amount of the each object 102 from the object tracking devices 104.

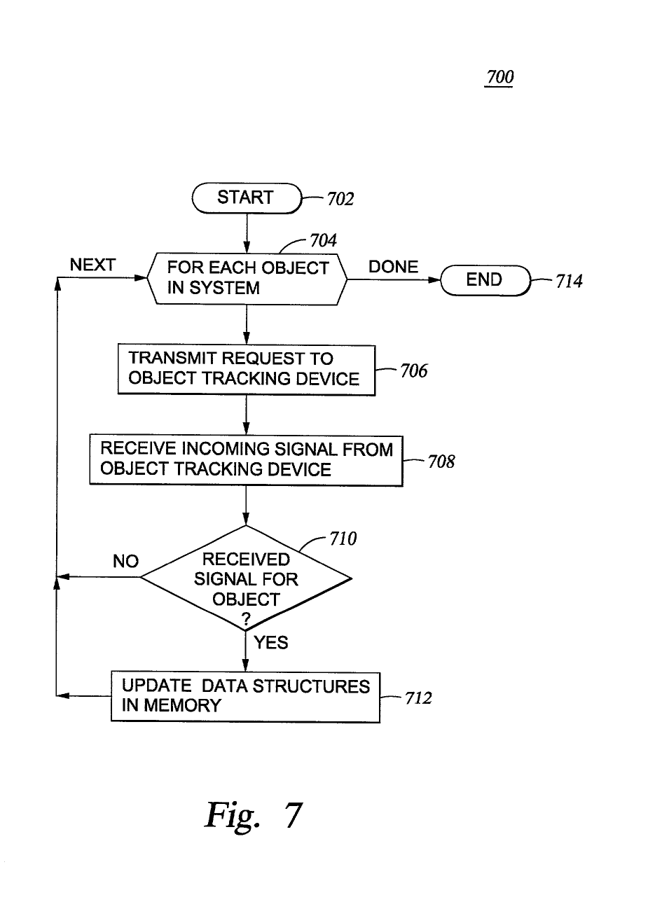

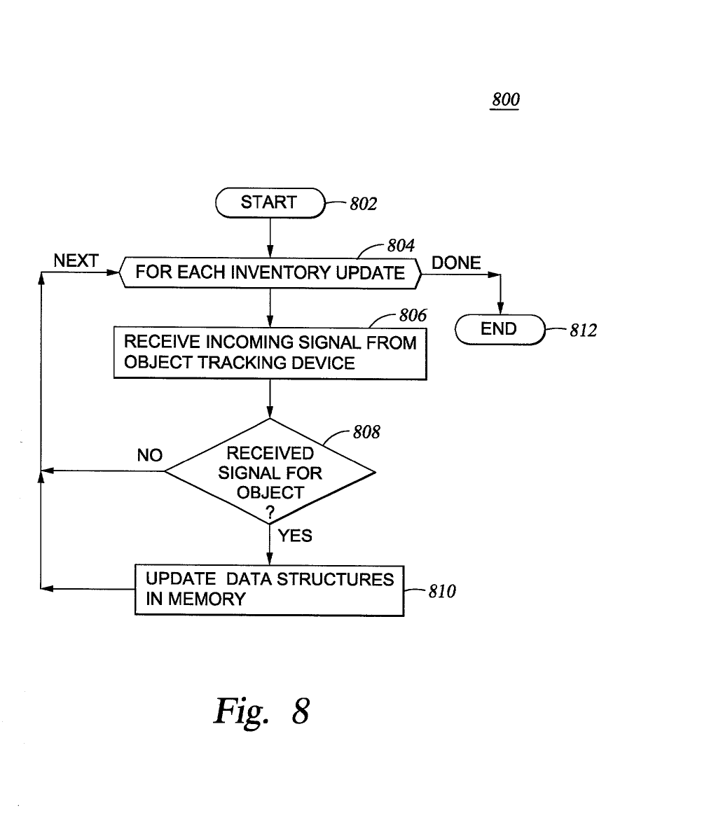

The inventory tracking center 106 may operate in either an “active” mode or a “passive” mode. In the active mode, the inventory tracking center 106 transmits a request to each of the object tracking devices 104 via the network 112. The object tracking devices 104 then determine the available amount of the respective object 102 and transmit the determined amount back to the inventory tracking center 106. In the passive mode, the inventory tracking center 106 simply receives (without first sending an explicit request) the available amount of the object 102 in the form of signals transmitted from the object tracking devices 104. A method for the active mode of operation is further described with respect to FIG. 7 and a method for the passive mode of operation is further described with respect to FIG. 8.

The local computer terminal 108 is a computer terminal that is local to the inventory tracking center 106, e.g., connected to the inventory tracking center 106 via the network 114, e.g., a local area network. The remote computer 110 is a computer terminal that is remotely located from the inventory tracking center 106, i.e., coupled to the inventory tracking center 106 via the network 114, e.g., a wide area network. Both the local computer terminal 108 and the remote computer terminal 110 may communicate with the inventory tracking center 106. For example, either the local computer terminal 108 or the remote computer terminal 110 may transmit a command to the inventory tracking center 106 for the purpose of obtaining the current amount of the objects 102. The local computer terminal 108 and the remote computer terminal 110 may also receive the results of the inventory tracking, e.g., the available amount of the objects 102, from the inventory tracking center 106.

In general, the networks 112 and 114 may be any type of network connection including land-based or wireless networks. The network 112 is used to transmit signals between the object tracking devices 104 and the inventory tracking center 106. The network 114 is used to transmit signals between the inventory tracking center 106, the local computer terminal 108 and the remote computer terminal 110.

In one embodiment, either network 112 or 114 may comprise a collection of networks known as the Internet. Individual networks within the Internet may comprise a point to point network, e.g., a plain old telephone system (POTS) network, a broadcast network, e.g., a wireless or RF network, and the like. Transmission of video and control signals through the network 130 is performed in accordance with standard transmission formats, e.g., TCP/IP (Transmission Control Protocol/Internet Protocol), ATM (Asynchronous Transfer Mode), SONET (Synchronous Optical Network) and the like.

FIG. 2 depicts a block diagram of the inventory tracking center 106 in the system 100 of FIG. 1. The inventory tracking center 106 and the object tracking devices 104 provide automated tracking of objects 102 that are capable of being consumed and replenished. In one embodiment, the inventory tracking center 106 comprises a processor 202, a memory 204 and a position detector 206.

The memory 204 stores the necessary data and programming structures necessary for the operation of the inventory tracking device 106. In one embodiment, the memory 204 stores the operating system 206, the inventory tracking program 208 and data structures 210. The memory 204 may comprise a combination of memory devices including random access memory (RAM), nonvolatile or backup memory (e.g., programmable or flash memories, read only memories (ROM), and the like).

The operating system 206 manages the operation of the inventory tracking center 106. Namely, the operating system 206 coordinates the receipt signals from and the transmission of signals to the object tracking devices 104, the local computer terminal 108 and the remote computer terminal 110. The inventory tracking program 208 contains instructions for automatically tracking the inventory of objects that are capable of being consumed and replenished. The data structures 210 contain information relating to the objects 102. In one embodiment, the data structures 210 contain the state or amount of the object 102 available for consumption. One embodiment of the data structure 210 stored in the memory 204 is further described with respect to FIG. 4.

The processor 202 performs instructions based upon the requirements of the operating system 206 and the inventory tracking program 208 stored in the memory 204. The processor 202 executes the inventory tracking program 208 to operate the inventory tracking center 106 within the system 100. In one embodiment with the inventory tracking center 106 in an active mode, the processor 202 transmits a request signal to the object tracking devices 104. The processor 202 then receives the amount of object that is available as determined from the object tracking devices 202. In another embodiment with the inventory tracking center 106 in a passive mode, the processor 202 simply receives the amount of object available as determined from the object tracking devices 104.

The processor 202 may also receive a command to obtain the inventory of the objects 102, i.e., the status or amount of each object that is available. Such a command is provided from either the local computer terminal 108 or the remote computer terminal 110. Additionally, the processor 202 may store the signal received from the object tracking devices 104 into the memory 204. The processor 202 may also transmit the inventory of the objects 102 for display on the output device 220, the local computer terminal 108 or the remote computer terminal 110.

The support circuits 212 include devices that support the operation of the inventory tracking center 206. Examples of support circuits include a power supply, a clock, and the like. The input/output interface 214 enables the coordination of the input device 218 and the output device 220 with the inventory tracking center 206. Namely, the input/output interface 214 enables the input device 218 to issue a request to the object tracking devices 104 and the output device 220 to display the inventory of the objects. The network interface 216 enables the inventory tracking device 106 to receive and transmit signals with the object tracking devices 104 via the network 112 and with the local and remote computer terminals 108 and 110 via the network 114. Examples to the network interface 216 include a modem, a network interface card, and the like.

The input device 218 may comprise any device utilized to provide input to the inventory tracking center 106. Examples of the input device 218 include a keypad, a microphone, a touch screen, a light pen, and the like. The output device 220 may comprise any device utilized to provide output for the inventory tracking center 106. Examples of the output device 220 include a speaker and a display. Although the output device 220 is shown separately from the input device 218, the output device 220 may be combined with the input device 218.

FIG. 3 depicts a data structure 300 of a signal transmitted from the remote computer terminal 110 to the inventory tracking center 106. In one embodiment, the data structure 300 comprises an object identifier field 302, an object descriptor field 304 and an object action field 306. The object identifier field 302 identifies an object 102 in the system 100. The object descriptor field 304 provides information on the object 102. For example, the object descriptor field 304 may contain information on the type of object 102 and/or the location of the object 102 in the system 100. The object action field 306 contains the type of action or command requested from the local computer terminal 108 or the remote computer terminal 110. Types of action may include a command to update the inventory of the objects 102 or a command to display the current inventory stored in the memory 204.

FIG. 4 depicts a format of a data structure 210 of a signal stored in the memory 204 of the inventory tracking center 106. In one embodiment, the data structure 210 comprises an object identifier field 402, an object descriptor field 404, a current state field 406, an expected state field 408 and an action indicator field 410. The object identifier field 402 identifies an object 102 in the system 100. The object descriptor field 404 may contain information on the type of object 102 and/or the location of the object 102 in the system 100. The current state field 406 represents the state or amount of the object 102 determined as available for consumption. The expected state field 408 represents the expected amount of the object 102 that is available. The action indicator field 410 indicates the last action on the data structure 210. For example, the action indicator field 410 may indicate a receipt of the current status from the object tracking devices 102 or to print out the inventory of the objects 102 on the output device 220.

FIG. 5 depicts a data structure 500 of a signal transmitted from the object tracking device 104 to the inventory tracking center 106. In one embodiment, the data structure 500 comprises an object identifier field 502, an object descriptor field 504 and a current state field 506. The object identifier field 502 identifies an object 102 in the system 100. The object descriptor field 504 may contain information on the type of object 102 and/or the location of the object 102 in the system 100. The current state field 506 represents the state or amount of the object 102 determined as available for consumption.

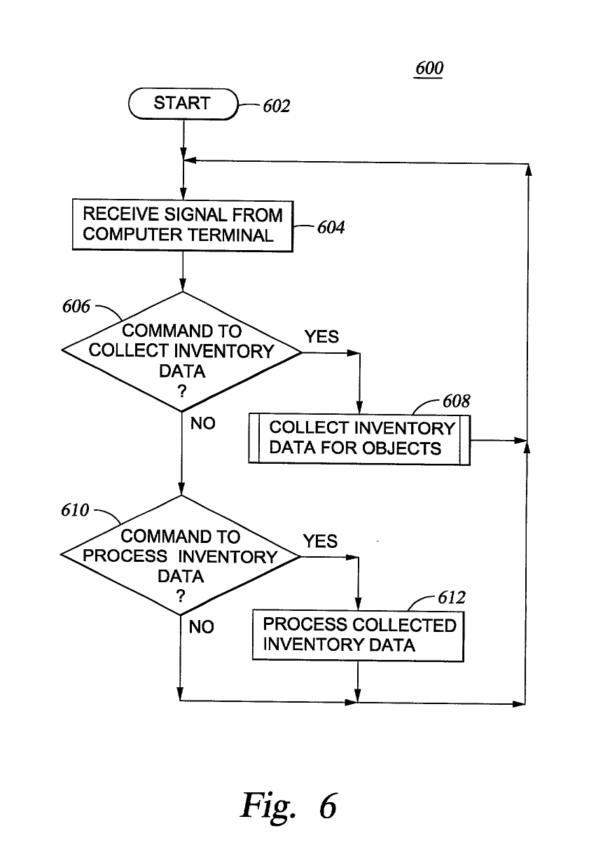

FIG. 6 depicts a flow diagram of a method 600 for processing input data received at the inventory tracking center 106. The method 600 starts at step 602 and proceeds to step 604 where a signal is received from the either the local computer terminal 108 or the remote computer terminal 110. At step 606, a query determines whether the received signal is a command to collect or obtain inventory data, i.e., the amount of at least one object 102 available for consumption. If the received signal is a command to collect inventory data, the method 600 proceeds to step 608 where inventory data is collected for one or more objects 102 in the system 100. Step 608 is further described with respect to FIGS. 7-8. After collecting inventory data for the objects 102, the method 600 returns to step 604, where the next signal is received from the local computer terminal 108 or the remote computer terminal 110.

If the command is not to collect inventory data for the objects 102 at step 606, the method 600 proceeds to step 610 where a query determines whether the received signal is a command to process previously collected or received inventory data. If the command is not to process inventory data, the method 600 returns to step 604, where the next signal is received from the either the local computer terminal 108 or the remote computer terminal 110. If the command is to process the inventory data, the method 600 proceeds to step 612 where the previously collected inventory data is processed.

Step 612 may represent different operations performed on the received inventory data, i.e., amount of the objects 102 available for consumption. One example of step 612 may include providing a table for display on the output device 220, the local computer terminal 108 or the remote computer terminal 110. Another example of step 612 is to determine whether the amount of the object 102 is below a threshold level or threshold amount. If the amount of the object is below the threshold level or threshold amount, step 612 would provide an alarm at either the output device 220, the local computer terminal 108 or the remote computer terminal 110. After processing the previously collected inventory data at step 612, the method 600 returns to step 604 where the next signal is received from either the local computer terminal 108 or the remote computer terminal 110.

FIG. 7 depicts a flow diagram of one embodiment of a method 700 for collecting data from the objects 102. The method 700 is previously described with respect to step 608. The method 700 represents an active mode of operation for the inventory tracking center 106. Specifically, the method 700 starts at step 702 and proceeds to step 704 where each object 102 in the system 100 is processed. The method 700 proceeds to step 706 where a request for inventory information is transmitted to the object tracking device 104 for the object 102. The object tracking device 104 obtains the current status or amount available of the object 102 in response to request and transmits the status of the object 102 to the inventory tracking center 106.

At step 708, the signal from the object tracking device 104 is received for the object 102. The signal received from the object tracking device 104 may have a data structure 300 described with respect to FIG. 5. The method 700 proceeds to step 710 where a query determines whether the received signal is for an object 102 in the system 100. In one embodiment, step 710 determines whether an object identifier 510 in the received signal is associated with an object 102 in the system 100. Step 710 operates to filter out unwanted signals, e.g., noise.

If the received signal is not for an object 102 in the system 100, the method 700 returns to step 704 where the next object 102 in the system 100 is processed. If the received signal is for an object 102 in the system 100, the method 700 proceeds to step 712 where the data structure 210 is updated in the memory 204. One embodiment of the data structure 210 is described with respect to FIG. 4.

After updating the inventory data in the memory 204, the method 700 returns to step 704 where the next object 102 is processed. Once all the objects 102 in the system 100 are processed, the method 700 proceeds to end at step 714.

FIG. 8 depicts a flow diagram of another embodiment of a method 800 for collecting data from objects 102. In contrast with the method 700 of FIG. 7, the method 800 implements a passive mode of operation for the inventory tracking center 106. Specifically, the method 800 starts at step 802 and proceeds to step 804 where each inventory update from the inventory trackers 104 is processed. In one embodiment, the object tracking devices 104 are configured to automatically transmit inventory data for respective different objects 102 at different intervals. For example, the object tracking device 104 for a first object 102 may transmit inventory data every thirty minutes, while the object tracking device 104 for a second object 102 may transmit inventory data every three hours.

At step 806, incoming signal is received from one of the object tracking devices 104. One embodiment of the data structure 500 for the received signal is described with respect to FIG. 5. The method 800 proceeds to step 808 where a query determines whether the received signal is for an object 102 in the system 100. Step 808 is similar to step 710 of FIG. 7. Namely, one embodiment of step 808 determines whether an object identifier 502 in the received signal is one of a preset numbers associated with an object 102 in the system 100.

If the received signal is not for an object 102 in the system 100, the method 800 returns to step 804 where the next inventory update is processed. If the received signal is for an object 102 in the system 100, the method 800 proceeds to step 810 where the data structure 210 is updated in the memory 204. One embodiment of the data structure 210 is described with respect to FIG. 4.

After updating the data structure 210 in the memory 204, the method 800 returns to step 804 where the next inventory update is processed. Once all the inventory updates have been processed, the method 800 proceeds to end at step 812.

The foregoing embodiments have particular application in a warehouse, or other large-scale industrial or commercial environment. In such environments is often desirable, and sometimes critical, to maintain inventory levels. For example, sufficient levels of fluids may be needed for manufacturing, running heavy equipment, as ingredients in food items or as consumer inventory for sale. In such cases, monitoring and maintaining inventory levels is necessary to avoid stalling the processing and detrimentally affecting throughput. On the other hand, it may be undesirable to maintain a large stock of inventory, as a result of the cost associated therewith. Accordingly, the present embodiments facilitate a just-in-time (JIT) inventory system, whereby inventory is replenished as needed. In particular, the inventory for a plurality of objects may be monitored. Once the inventory levels fall below a threshold, a supplier may be contacted to replenish one or more of the inventory objects.

Although various embodiments which incorporate the teachings of the present invention have been shown and described in detail herein, those skilled in the art can readily devise many other varied embodiments that still incorporate these teachings.

What is claimed is:

1. A method for tracking an inventory of a plurality of objects capable of being consumed and replenished and located in a commercial environment, the method comprising:
receiving a signal from a plurality of object tracking devices for the plurality of objects, where each object tracking device determines an amount of each object that is available for consumption and transmits the determined amount in the signal; and
for at least one of the plurality of objects, notifying a supplier of at least one of the determined amount and an amount needed to replenish the at least one of the plurality of objects.

2. The method of claim 1 wherein the supplier replenishes at least one of the plurality of objects after the notifying.

3. The method of claim 1 wherein the supplier is a company.

4. The method of claim 1 wherein notifying comprises sending a network message to the supplier.

5. The method of claim 1 wherein the notifying comprises displaying the determined amount for each of the plurality of objects on a display.

6. The method of claim 1 wherein the receiving comprises:
receiving the signal from a network; and
determining whether the received signal from the network contains data for the determined amount of one of the plurality of objects.

7. The method of claim 1 further comprising receiving a command from a computer terminal, where the command comprises an instruction to obtain the amount of at least one of the plurality of objects that is available for consumption.

8. The method of claim 1 further comprising transmitting a request to the plurality of object tracking devices, where each object tracking device, in response to the request, determines the amount of each object available and transmits the determined amount.

9. The method of claim 1 wherein each of the plurality of object tracking devices repeatedly determines the amount of each object available and transmits the determined amount without a need for an explicit request.

10. The method of claim 1 further comprising:
determining whether the determined amount for each of the plurality of objects is below a threshold amount for each of the plurality of objects; and
initiating an alarm if the determined amount is below the threshold amount for at least one of the plurality of objects.

11. The method of claim 1 wherein at least one of the plurality of objects comprises a household item.

12. The method of claim 1 wherein the commercial environment is a warehouse.

13. A system for tracking an inventory of a plurality of objects capable of being consumed and replenished and located in a warehouse, the system comprising:
a plurality of object tracking devices configured to determine an amount of the plurality of objects available for consumption and to transmit the determined amount; and
an inventory tracking center configured to receive the determined amount transmitted from the plurality of object tracking devices and further configured to notify a supplier capable of replenishing at least one of the plurality of objects.

14. The system of claim 13 further comprising a computer terminal configured to issue a command to the inventory tracking center to receive the determined amount of the plurality of objects.

15. The system of claim 14 further comprising a display device for displaying the determined amount received at the inventory tracking center.

16. The system of claim 13 wherein each of the plurality of objects is housed in a container connected to one of the plurality of object tracking devices.

17. The system of claim 13 wherein the inventory tracking center is configured to determine the amount of at least one of the plurality of objects that needs to be replenished.

18. The system of claim 13 wherein the inventory tracking center and the plurality of object tracking devices are coupled to a network.

19. The system of claim 13 wherein at least one of the object tracking devices respond to an inventory request from the inventory tracking center.

20. The system of claim 13 wherein the inventory tracking center is coupled to at least one supplier via a network.

21. The system of claim 13 wherein the at least one of the plurality of objects comprises a household item.

22. An apparatus for tracking an inventory of a plurality of objects capable of being consumed and replenished and located in a warehouse, the apparatus comprising:
a memory for storing an inventory tracking program;
a network interface configured to communicate with a supplier capable of replenishing at least one of the plurality of object and configured to communicate with a plurality of object tracking devices for the plurality of objects; and
a processor which is configured by executing the inventory tracking program to:
receive a signal from the plurality of object tracking devices, where each object tracking device determines an amount of each object that is available for consumption and transmits the determined amount in the signal, and
notify the supplier of at least one of the determined amount an a refill amount of at least one of the plurality of objects.

23. The apparatus of claim 22 wherein processor is configured to notify the supplier only when the determined amount is below a threshold amount.

24. The apparatus of claim 22 wherein the processor is configured to receive a command from a computer terminal, wherein the command comprises an instruction to obtain the amount of at least one of the plurality of objects that is available for consumption.

25. The apparatus of claim 22 wherein the processor is configured to transmit a request to the plurality of object tracking devices, where each object tracking device, in response to the request, determines the amount of each object available and transmits the determined amount.

26. The apparatus of claim 22 wherein each of the plurality of object tracking devices repeatedly determines the amount of each object available and transmits the determined amount without a need for a request.

27. The apparatus of claim 22 wherein the processor is configured to determine whether the determined amount for each of the plurality of objects is below a threshold amount for each of the plurality of objects, and initiate an alarm if the determined amount is below the threshold amount for at least one of the plurality of objects.

28. The apparatus of claim 22 wherein at least one of the plurality of objects is a household item.
